(19) United States
(12) Patent Application Publication
(10) Pub. No.: US 2010/0088406 A1
(43) Pub. Date: Apr. 8, 2010

(54) METHOD FOR PROVIDING DYNAMIC CONTENTS SERVICE BY USING ANALYSIS OF USER'S RESPONSE AND APPARATUS USING SAME

(75) Inventors: Jeong-rok Yu, Suwon-si (KR); Moon-sang Lee, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/564,152

(22) Filed: Sep. 22, 2009

(30) Foreign Application Priority Data
Oct. 8, 2008 (KR) 10-2008-0098782

(51) Int. Cl. G06F 15/173

(52) U.S. Cl. 709/224

(57) ABSTRACT

A method of providing a dynamic content service using an analysis of a user's response, the method including: monitoring the response of the user watching and/or listening to first content; analyzing preference information with respect to one or more scenes included in the first content, based on the monitored user's response; transmitting, to an external server, metadata of the analyzed preference information; receiving, from the external server, second content generated based on the metadata of the analyzed preference information; and outputting the received second content onto a screen.

### CROSS-REFERENCE TO RELATED APPLICATION

This application claims the benefit of Korean Patent Application No. 10-2008-0098782, filed on Oct. 8, 2008 in the Korean Intellectual Property Office, the disclosure of which is incorporated herein in its entirety by reference.

### BACKGROUND OF THE INVENTION

1. Field of the Invention

Aspects of the present invention relate to a method of providing a dynamic content service by using an analysis of a user's response and an apparatus using the same.

2. Description of the Related Art

Recently, there has been increased interest in television (TV) media utilizing the Internet due to digital and interactive advantages. In Internet TV or digital multimedia broadcasting (DMB) reproduction devices, an analysis of a user's taste (or preferences) with respect to programs and digital content is an essential element in dynamic services. Such dynamic services includes providing demographic-based digital content, personalized customized content, and advertisement services. In particular, in an environment in which advertisements inserted in the middle of a program can be provided by a major broadcasting station, the importance of technology to analyze the preference of viewers has increased. However, when the preference of a viewer with respect to a program or digital content is analyzed, in most cases, a method whereby a viewer's direct input (i.e., explicit rating) for a program or unit of content is utilized, in which the viewer inputs information on whether the viewer is satisfied with the program or content, or inputs scores.

### SUMMARY OF THE INVENTION

Aspects of the present invention provide a dynamic content service method by using an analysis of preference information on one or more scenes included in digital content, and an apparatus using the same. Here, a dynamic content service client and a dynamic content service server are provided as apparatuses.

According to an aspect of the present invention, there is provided a method of providing a dynamic content service using an analysis of a user's response, the method including: monitoring the response of the user watching and/or listening to first content; analyzing preference information with respect to one or more scenes included in the first content, based on the monitored user's response; transmitting, to an external server, metadata of the analyzed preference information; receiving, from the external server, second content generated based on the metadata of the preference information; and outputting the received second content onto a screen.

The second content may be generated based on an age information item, a sex information item, an area information item, another demographic information item about the user, and/or a similar preference of the user common among other viewers.

The second content may be generated by re-editing one or more scenes included in the first content based on the received metadata of the preference information.

The monitoring of the response of the user may include capturing video and/or audio of the user while the first content is being watched and/or listened to.

The analyzing of the preference information with respect to the scenes of the first content may include extracting information on the one or more scenes included in the first content by analyzing the captured video and/or the captured audio of the user.

The outputting of the received second content onto the screen may include outputting the received second content in an idle period of the first content or onto the screen in a picture in picture (PIP) mode.

The transmitting of the metadata of the preference information to the external server may include transmitting the metadata of the preference information periodically or in real-time.

According to another aspect of the present invention, there is provided a dynamic content service method using an analysis of a user's response, the method including: receiving metadata of preference information analyzed in relation to one or more scenes included in first content based on monitored responses of the user watching and/or listening to the first content; generating second content based on the received metadata of the preference information; and transmitting the generated second content to the user.

The second content may be generated based on one or more information items from an age information item, a sex information item, an area information item, another demographic information item about the user, and/or a similar preference of the user common among other viewers.

The second content may be obtained by re-editing one or more scenes included in the first content based on the metadata of the preference information.

The second content may be advertisement content based on the metadata of the preference information.

According to another aspect of the present invention, there is provided a dynamic content service client using an analysis of a user's response, the client including: a sensor unit to monitor the response of the user watching and/or listening to first content; a preference detection unit to analyze preference information with respect to one or more scenes included in the first content, based on the monitored user's response; a network interface to transmit metadata of the analyzed preference information to an external server; a broadcast reception unit to receive second content generated based on the metadata of the preference information from the external server; and a display unit to output the received second content onto a screen.

The second content may be generated based on an age information item, a sex information item, an area information item, another demographic information item about the user, and/or a similar preference of the user common among other viewers.

The second content may be generated by re-editing one or more scenes included in the first content based on the metadata of the preference information.

The sensor unit may capture video and/or audio of the user while the first content is being watched and/or listened to.

The preference detection unit may include a preprocessing unit to extract information about the one or more scenes included in the first content, by analyzing the captured video and/or the captured audio of the user.

The display unit may output the second content in an idle period of the first content or may output the second content onto the screen in a picture in picture (PIP) mode.

The network interface may transmit the metadata of the preference information periodically or in real-time.

According to another aspect of the present invention, there is provided a dynamic content service server using an analysis of a user's response, the server including: a metadata reception unit to receive metadata of preference information analyzed in relation to one or more scenes included in first content based on monitored response of the user watching and/or listening to the first content; a content generation unit to generate second content based on the received metadata of the preference information; and a broadcast transmission unit to transmit the generated second content to the user.

The second content may be generated based on an age information item, a sex information item, an area information item, another demographic information item about the user, and/or a similar preference of the user common among other viewers.

The second content may be generated by re-editing one or more scenes included in the first content based on the metadata of the preference information.

The sensor unit may capture video and/or audio of the user while the first content is watched and/or listened to.

According to another aspect of the present invention, there is provided a computer readable recording medium having embodied thereon a computer program to execute the dynamic content service method.

According to yet another aspect of the present invention, there is provided a method of providing a dynamic content service using an analysis of a response of a user, the method including: monitoring, by a client device, the response of the user watching and/or listening to first content; transmitting, from the client device to an external server, information with respect to one or more scenes included in the first content, based on the monitored response of the user; receiving, by the client device from the external server, second content generated according to an analysis, by the external server, of the transmitted information of the one or more scenes; and outputting the received second content onto a screen.

According to still another aspect of the present invention, there is provided a dynamic content service method using an analysis of a monitored response of a user, the method including: receiving, by a server from a client device, information with respect to one or more scenes included in first content based on the monitored response of the user watching and/or listening to the first content; analyzing, by the server, the received information; generating, by the server, second content based on metadata of the analyzed information; and transmitting the generated second content to the client device.

According to another aspect of the present invention, there is provided a dynamic content service client using an analysis of a response of a user, the client including: a dynamic content service client including: a sensor unit to monitor the response of the user watching and/or listening to first content, a preference detection unit to analyze preference information with respect to one or more scenes included in the first content, based on the monitored response of the user, a network interface to transmit metadata of the analyzed preference information, a broadcast reception unit to receive second content, and a display unit to output the received second content onto a screen; and a dynamic content service server including: a metadata reception unit to receive, from the client, the metadata of the analyzed preference information, a content generation unit to generate the second content based on the received metadata of the analyzed preference information, and a broadcast transmission unit to transmit the generated second content to the client.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart explaining a dynamic content service method using an analysis of a user's response according to an embodiment of the present invention;

FIG. 2 is a flowchart explaining a dynamic content service method according to another embodiment of the present invention;

FIG. 3 is a diagram illustrating each operation process between a client and a server according to an embodiment of the present invention;

FIG. 4 is a functional block diagram illustrating a dynamic content service client using an analysis of a user's response according to an embodiment of the present invention; and

FIG. 5 is a functional block diagram illustrating a dynamic content service server using an analysis of a user's response according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

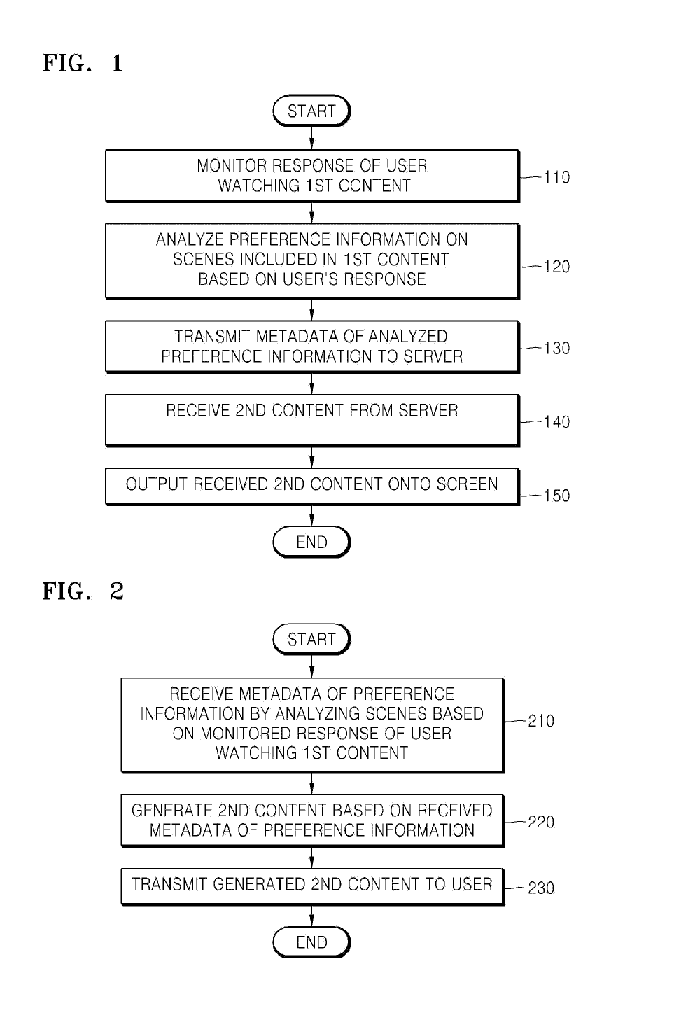

FIG. 1 is a flowchart explaining a dynamic content service method using an analysis of a user's response according to an embodiment of the present invention. Aspects of the present invention provide a dynamic content service method using an analysis of scenes preferred by a user in an Internet TV or a digital multimedia broadcasting (DMB) device through input methods such as tracking of a voice of a user watching and/or listening to digital content, tracking a motion of the user's body, tracking a motion of the user's eyes, and/or behavior pattern collection.

Referring to FIG. 1, the method of providing a dynamic content service by using analysis of the user's response includes monitoring the response of the user watching and/or listening to first content in operation 110, analyzing preference information on one or more scenes included in the first content based on the monitored user's response in operation 120, transmitting metadata of the analyzed preference information to an external server in operation 130, receiving second content generated based on the metadata of the preference information from the external server in operation 140, and outputting the received second content on the screen in operation 150.

In detail, the response of the user watching and/or listening to digital content is monitored in operation 110. The response of the user watching and/or listening to the digital content (hereinafter, referred to as first content) such as a broadcast program can be tracked by a variety of audio or video signals. For example, a vocal sound such as a cheer, a body movement such as a gesture, facial expressions such as frowning or smiling, and changes in the pupils of the eyes may be tracked. In operation 110, this response of the user is sensed, as opposed to a conventional method whereby the viewer directly inputs information indicating whether the viewer is satisfied with a program, or inputs scores for the program. However, this conventional method prevents the viewer from concentrating on the program or digital content, and in addition, makes it difficult to provide an appropriate dynamic service matching the preference of the viewer. Accordingly, aspects of the present invention provide a method of automatically sensing the response of the user, as described above.

Preference information with respect to one or more scenes included in the first content is analyzed based on the monitored response of the user in operation 120. In general, digital content of audio/video (A/V) moving pictures includes a plurality of scenes, and a user may have different preferences with respect to each scene. In the current embodiment, by using the preference of the user for each scene, the response of the user is sensed, and the preference information of the user is analyzed so that the user's taste can be identified for each scene. By performing this analysis (operation 120), for example, information about scenes including a most preferred actor, from among a plurality of actors appearing in a drama, can be extracted, and new digital content of trailer scenes formed mainly with these scenes or scenes for a drama summary can be generated. Also, based on metadata that is obtained from each scene having a higher user preference, the disposition of the user can be analyzed (operation 120). Based on the analysis, personalized customized content (for example, advertisement services) can also be provided.

The metadata of the analyzed preference information is transmitted to an external server in operation 130. The method of transmission may include wired and/or wireless networks (such as the Internet or an IEEE 1394 network) and/or communications protocols (such as infrared, WiFi, Bluetooth, USB, etc.). An identifier may also be transmitted together with the metadata so that the external server receiving the metadata can recognize the user. The transmission may be performed in a predetermined time interval or in real-time.

Digital content generated based on the metadata of the preference information from the external server is received in operation 140. The digital content (hereinafter, referred to as second content) received from the external server is generated based on the preference information of the user. The second content may be generated based on information items regarding age, sex, and/or area, which are demographic information on the user, and/or a similar preference. That is, the content is generated based on information obtained from the age group, sex group, and/or area group to which a user belongs, and/or another user group having a similar preference. Moreover, the generated content is broadcast. Furthermore, the second content may be generated by re-editing one or more scenes included in the first content based on the metadata of the preference information. For example, the content may be re-edited with scenes for a summary of a broadcast program or highlight scenes of a sporting event.

The second content received from the external server is output in operation 150. For example, the received second content may be output in an idle period of the first content or may be output onto the screen to be viewed by the user in a picture in picture (PIP) method.

FIG. 2 is a flowchart explaining a dynamic content service method according to another embodiment of the present invention. Referring to FIG. 2, the dynamic content service method according includes receiving metadata of preference information analyzed in relation to at least one or more scenes included in first content based on monitored responses of a user watching and/or listening to the first content in operation 210, generating second content based on the received metadata of the preference information in operation 220, and transmitting the generated second content to the user in operation 230.

These operations are performed on a server side of a network. The metadata of analyzed preference information of individual scenes of the content is received in operation 210, and new content (i.e., the second content) is generated based on the received metadata in operation 220. This second content may be generated based on information about age, sex, and/or area, which are user demographic information, and/or a similar preference. In particular, the second content may be generated by re-editing one or more scenes included in the first content based on the metadata of the preference information of the user. For example, according to the metadata of preference information for each scene of the content of the user, a preference for people (such as favorite actors, athletes, and comedians), a preference for products (such as cars and accessories), and/or a preference for places (such as tourist resorts in each country) may be identified. The generated second content is transmitted to the user in operation 230, and the second content may be displayed during an advertisement break or on a PIP screen.

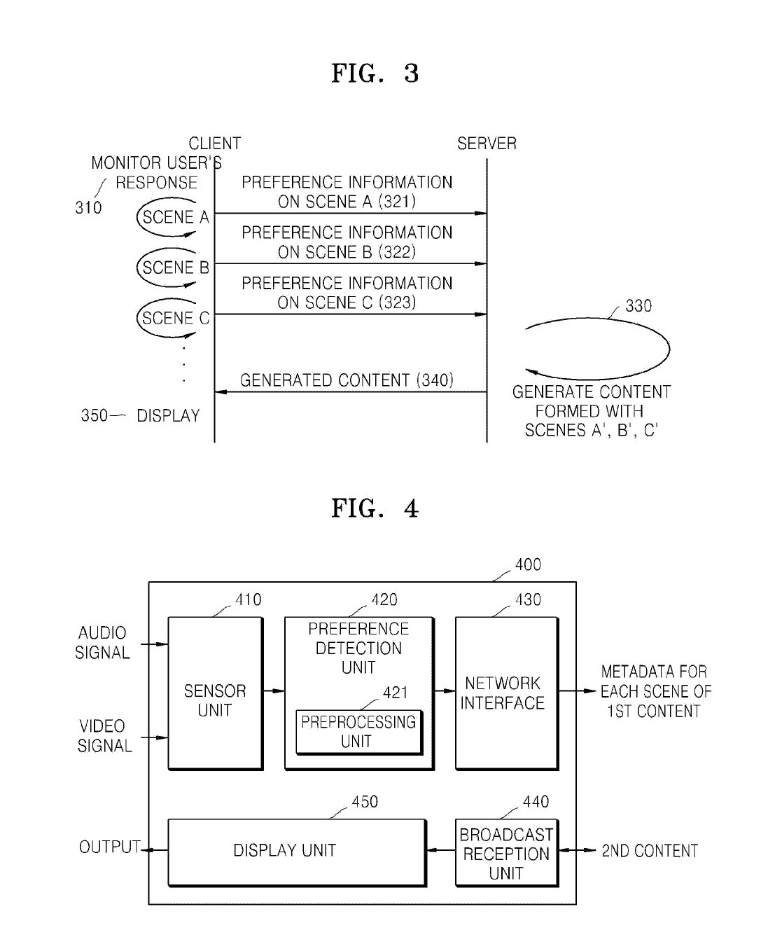

FIG. 3 is a diagram illustrating each operation process between a client and a server according to an embodiment of the present invention. Referring to FIG. 3, a sequential process of transmission and reception of data between the client and server is shown.

On the client side, the response of a user for each scene of digital content is monitored in operation 310, and preference information with respect to each scene (for example, scene A, scene B, and scene C) is transmitted to the server in operations 321 to 323. This transmission may be performed in real-time or periodically at predetermined intervals. The server generates digital content formed with scene A′, scene B′, and scene C′, based on the received preference information of the scene A, scene B, and scene C in operation 330. This generated digital content is transmitted to the client in operation 340 and the client displays the received content in operation 350. This process may vary according to several different scenarios as follows.

In an embodiment of the present invention, by tracking a voice, gesture, facial expression, and/or pupils of the eyes of a user watching a popular drama, preferred scenes (for example, peak scenes, scenes including drama heroes, scenes including witty supporting actors, etc.) are recognized. Metadata of the recognized preferred scenes or favorite scenes is transmitted to the server. Then, by utilizing demographics-based information of viewer groups (such as the same age, sex, and area groups) in relation to the received metadata information, the server filters common preference scenes or metadata of the group. By utilizing the analyzed information, scenes for a drama summary or trailer scenes are reconstructed, and this content is transmitted to the client (such as a TV receiver). The client displays the received data to the user at an appropriate time. Compared to conventional uniform contents unilaterally (one-way) provided by broadcasting stations, the shown embodiment has an advantage in that customized content reconstructed based on the preferences of the viewer can be provided.

In another embodiment of the present invention, in a sports game between national squads, when a viewer cheers or a dramatic play is shown during a specific scene (for example, a goal scoring scene or a scene in which a popular sport star is playing), information related to the scene is transmitted to the server, and the server selects corresponding highlight scenes for the viewer by using the received information (for example, a scene not broadcast but captured by other cameras from different angles). Then, the related data is transmitted to the TV receiver. Later, the received data can be combined and output to the viewer during a break or on a PIP screen. By doing so, the basic method in which the broadcasting stations always show the same briefed scenes can be avoided.

In another embodiment, while the viewer watches a comedy program, a laughing sound, facial expression, and behavioral pattern of the viewer during a specific scene (for example, a scene in which a favorite character appears, or during a funny scene) is analyzed and the preference for each scene is extracted. Then, metadata information of the scenes is transmitted to the server. By analyzing the information, the server may be able to prepare a trailer combining scenes in which related characters appear, and may transmit this trailer to a TV receiver. Later, program trailer content customized for the viewer is output to the viewer. Also, the information about the viewer's preferred scenes can be used for a sharing purpose with other viewers or buddies through the server.

FIG. 4 is a functional block diagram illustrating a dynamic content service client 400 using an analysis of a user's response according to an embodiment of the present invention. Referring to FIG. 4, the dynamic content service client 400 includes a sensor unit 410 to monitor a response of a user watching and/or listening to first content, a preference detection unit 420 to analyze preference information with respect to one or more scenes included in the first content based on the monitored user's response, a network interface 430 to transmit metadata of the analyzed preference information to an external server, a broadcast reception unit 440 to receive second content generated based on the transmitted metadata of the preference information from an external server, and a display unit 450 to output the received second content onto a screen. The preference detection unit 420 further includes a preprocessing unit 421 to extract information on one or more scenes included in the first content, by analyzing, for example, a video or audio signal of tracking information regarding voice, gesture, and pupils of the eyes. The dynamic content service client 400 may be a television, a set-top box, a television receiver, a computer, a handheld device, a mobile device, etc. Moreover, while not required, each of the units 410, 420, 430, 440, 450 can be one or more processors or processing elements on one or more chips or integrated circuits.

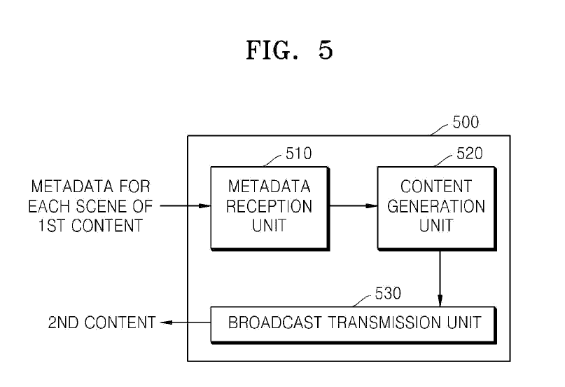

FIG. 5 is a functional block diagram illustrating a dynamic content service server 500 using an analysis of a user's response according to an embodiment of the present invention. Referring to FIG. 5, the dynamic content service server 500 includes a metadata reception unit 510 to receive metadata of preference information analyzed in relation to one or more scenes included in first content based on monitored responses of a user watching and/or listening to the first content, a content generation unit 520 to generate second content based on the received metadata of the preference information, and a broadcast transmission unit 530 to transmit the generated second content to the user. The dynamic content service server 500 may be a digital broadcast transmitter, a computer, a handheld device, a mobile device, a work station, etc. Moreover, while not required, each of the units 510, 520, 530 can be one or more processors or processing elements on one or more chips or integrated circuits.

According to the dynamic content service client and server described above, analysis of scenes of a program or content can be enabled naturally through analysis of voice, motion, and behavioral patterns of the viewer watching and/or listening to the program or content (for example, through an Internet TV or digital multimedia broadcasting device). Such analysis can be utilized to provide dynamic content or advertisement services.

Though aspects of the present invention have been described whereby a dynamic content service client 400 analyzes preference information of scenes based on user's responses, it is understood that aspects of the present invention are not limited thereto. For example, according to other aspects, the dynamic content service client 400 may transmit the preference information of scenes based on user's responses to the dynamic content service server 500 or another external device to be analyzed.

Aspects of the present invention can also be embodied as computer-readable codes on a computer-readable recording medium. The computer-readable recording medium is any data storage device that can store data which can be thereafter read by a computer system. Also, the data structure used in the embodiments of the present invention described above can be recorded on a computer-readable recording medium in a variety of ways. Examples of the computer readable recording medium include read-only memory (ROM), random-access memory (RAM), CD-ROMs, magnetic tapes, floppy disks, optical data storage devices. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of providing a dynamic content service using an analysis of a response of a user, the method comprising:
monitoring, by a client device, the response of the user watching and/or listening to first content;
analyzing, by the client device, preference information with respect to one or more scenes included in the first content, based on the monitored response of the user;
transmitting metadata of the analyzed preference information to an external server;
receiving, from the external server, second content generated according to the metadata of the preference information; and
outputting the received second content onto a screen.

2. The method as claimed in claim 1, wherein the second content is generated according to an age information item about the user, a sex information item about the user, an area information item about the user, another demographic information item about the user, and/or a similar preference of the user common among other viewers.

3. The method as claimed in claim 1, wherein the second content is generated by re-editing one or more scenes included in the first content based on the metadata of the analyzed preference information.

4. The method as claimed in claim 1, wherein the monitoring of the response of the user comprises capturing, by the client device, video and/or audio of the user while the first content is being watched and/or listened to.

5. The method as claimed in claim 4, wherein the analyzing of the preference information comprises extracting information on the one or more scenes included in the first content by analyzing the captured video and/or the captured audio of the user.

6. The method as claimed in claim 1, wherein the outputting of the received second content onto the screen comprises outputting the second content during an idle period of the first content or outputting the second content onto the screen simultaneously with the first content in a picture in picture (PIP) mode.

7. The method as claimed in claim 1, wherein the transmitting of the metadata comprises transmitting the metadata of the analyzed preference information at predetermined time intervals or in real-time.

8. The method as claimed in claim 4, wherein the analyzing of the preference information comprises analyzing the captured video and/or the captured audio of the user.

9. The method as claimed in claim 8, wherein:
the analyzing of the captured video and/or the captured audio of the user comprises detecting a predetermined video and/or a predetermined audio of the user from the captured video and/or the captured audio, respectively;
the predetermined audio includes a cheer; and
the predetermined video includes a body movement, a facial expression, and/or a changing of a pupil of an eye of the user.

10. The method as claimed in claim 1, wherein the client device is an Internet TV device.

11. The method as claimed in claim 1, wherein the monitoring of the response of the user comprises automatically sensing, by the client device, the response of the user.

12. A dynamic content service method using an analysis of a monitored response of a user, the method comprising:
receiving, from a client device, metadata of preference information analyzed in relation to one or more scenes included in first content based on the monitored response of the user watching and/or listening to the first content;
generating second content based on the received metadata of the preference information; and
transmitting the generated second content to the client device.

13. The method as claimed in claim 12, wherein the second content is generated according to an age information item about the user, a sex information item about the user, an area information item about the user, another demographic information about the user, and/or a similar preference of the user common among other viewers.

14. The method as claimed in claim 12, wherein the generating of the second content comprises generating the second content by re-editing one or more scenes included in the first content based on the metadata of the preference information.

15. The method as claimed in claim 13, wherein the generated second content is advertisement content based on the received metadata of the preference information.

16. A dynamic content service client using an analysis of a response of a user, the client comprising:
a sensor unit to monitor the response of the user watching and/or listening to first content;
a preference detection unit to analyze preference information with respect to one or more scenes included in the first content, based on the monitored response of the user;
a network interface to transmit metadata of the analyzed preference information to an external server;
a broadcast reception unit to receive, from the external server, second content generated according to the metadata of the preference information; and
a display unit to output the received second content onto a screen.

17. The client as claimed in claim 16, wherein the second content is generated according to an age information item about the user, a sex information item about the user, an area information item about the user, another demographic information about the user, and/or a similar preference of the user common among other viewers.

18. The client as claimed in claim 16, wherein the second content is generated by re-editing one or more scenes included in the first content based on the metadata of the analyzed preference information.

19. The client as claimed in claim 16, wherein the sensor unit captures video signal and/or audio of the user while the first content is being watched and/or listened to.

20. The client as claimed in claim 19, wherein the preference detection unit comprises a preprocessing unit to extract information on the one or more scenes included in the first content by analyzing the captured video and/or the captured audio of the user.

21. The client as claimed in claim 20, wherein the display unit outputs the second content during an idle period of the first content or outputs the second content onto the screen simultaneously with the first content in a picture in picture (PIP) mode.

22. The client as claimed in claim 17, wherein the network interface transmits the metadata of the analyzed preference information at predetermined time intervals or in real-time.

23. The client as claimed in claim 19, wherein the preference detection unit analyzes the captured video and/or the captured audio of the user.

24. The client as claimed in claim 23, wherein the preference detection unit detects a predetermined video and/or a predetermined audio of the user from the captured video and/or the captured audio, respectively.

25. The client as claimed in claim 24, wherein:
the predetermined audio includes a cheer; and
the predetermined video includes a body movement, a facial expression, and/or a changing of a pupil of an eye of the user.

26. The client as claimed in claim 16, wherein the client is an Internet TV device.

27. The client as claimed in claim 16, wherein the sensor unit automatically senses the response of the user.

28. A dynamic content service server using an analysis of a monitored response of a user, the server comprising:
a metadata reception unit to receive, from a client device, metadata of preference information analyzed in relation to one or more scenes included in first content based on the monitored responses of the user watching and/or listening to the first content;
a content generation unit to generate second content based on the received metadata of the preference information; and
a broadcast transmission unit to transmit the generated second content to the client device.

29. The server as claimed in claim 28, wherein the second content is generated based on at least one or more information items from among age, sex, and area, which are demographic information about the user, or a similar preference.

30. The server as claimed in claim 29, wherein the second content is obtained by re-editing at least one or more scenes included in the first content based on the metadata of the preference information.

31. The server as claimed in claim 29, wherein the sensor unit captures a video signal or audio signal generated by the user while the first content is watched and/or listened to.

32. A computer readable recording medium encoded with the method of claim 1 and implemented by the client device.

33. A computer readable recording medium encoded with the method of claim 12 and implemented by at least one computer.

34. A method of providing a dynamic content service using an analysis of a response of a user, the method comprising:
monitoring, by a client device, the response of the user watching and/or listening to first content;
transmitting, from the client device to an external server, information with respect to one or more scenes included in the first content, based on the monitored response of the user;
receiving, by the client device from the external server, second content generated according to an analysis, by the external server, of the transmitted information of the one or more scenes; and
outputting the received second content onto a screen.

35. The method as claimed in claim 34, wherein the monitoring of the response of the user comprises automatically sensing, by the client device, the response of the user.

36. A computer-readable recording medium encoded with the method of claim 34 and implemented by the client device.

37. A dynamic content service method using an analysis of a monitored response of a user, the method comprising:
receiving, by a server from a client device, information with respect to one or more scenes included in first content based on the monitored response of the user watching and/or listening to the first content;
analyzing, by the server, the received information;
generating, by the server, second content based on metadata of the analyzed information; and
transmitting the generated second content to the client device.

38. A computer-readable recording medium encoded with the method of claim 37 and implemented by the client device.

39. A dynamic content service client using an analysis of a response of a user, the client comprising:
a dynamic content service client comprising:
a sensor unit to monitor the response of the user watching and/or listening to first content,
a preference detection unit to analyze preference information with respect to one or more scenes included in the first content, based on the monitored response of the user,
a network interface to transmit metadata of the analyzed preference information,
a broadcast reception unit to receive second content, and
a display unit to output the received second content onto a screen; and
a dynamic content service server comprising:
a metadata reception unit to receive, from the client, the metadata of the analyzed preference information,
a content generation unit to generate the second content based on the received metadata of the analyzed preference information, and
a broadcast transmission unit to transmit the generated second content to the client.
